(19) United States
(12) Patent Application Publication
(10) Pub. No.: US 2010/0309619 A1
(43) Pub. Date: Dec. 9, 2010

(54) Metal display casing and display thereof

(75) Inventors: Steve Cheng, Tao Yuan Shien (TW); Chin-Fa Chang, Baihe Township (TW); Mao-Chen Hsiao, Shulin City (TW); Ying-Sheng Lin, Sinjhuang City (TW)

Correspondence Address: RABIN & Berdo, PC, 1101 14TH STREET, NW, SUITE 500, WASHINGTON, DC, 20005, US

(73) Assignee: Quanta Computer Inc., Taoyuan Shien (TW)

(21) Appl. No.: 12/461,981

(22) Filed: Aug. 31, 2009

(30) Foreign Application Priority Data
Jun. 6, 2009 (TW) 098210059

(51) Int. Cl. G06F 1/16

(52) U.S. Cl. 361/679.27

(57) ABSTRACT

A metal display casing is disclosed, which includes a base plate having an edge, a bending portion extended from the edge, a fold-back portion connected to the bending portion, and a screw hole disposed on the fold-back portion. A display utilizing the metal display casing is also disclosed.

### RELATED APPLICATIONS

This application claims priority to Taiwan Application Serial Number 98210059, filed Jun. 6, 2009, which is herein incorporated by reference.

### BACKGROUND

1. Field of Invention

The present invention relates to a display casing. More particularly, the present invention relates to a display casing of a notebook computer.

2. Description of Related Art

Liquid crystal displays have many advantages, such as high definition, small volume, lightweight, low voltage drive, low consumption of power, a broad range of applications, etc. Therefore, liquid crystal displays are already broadly used in consumer electronic devices or computer products, such as portable televisions, cellular phones, camcorders, laptop computers, desktop displays, projection televisions, etc., thereby becoming the main stream for displays.

The components of the liquid crystal display utilized in the notebook computer include a display panel, a frame, a casing . . . etc. The display panel is assembled in the frame. The material of the casing can be metal, such as aluminum. The aluminum substrate can be punched and shaped as the casing. The display panel and the casing are further fixed on the casing. The frame has a hinge to connect to the host of the computer notebook.

The conventional metal casing may further include a plastic connecting structure with a screw hole disposed thereon, thus the frame or the hinge can be screwed on plastic connecting structure with the screw hole. However, the plastic connecting structure needs to be separated from the metal casing before recycling, and that would generate extra cost and waste time.

### SUMMARY

An embodiment of the invention provides a metal display casing, which includes a base plate having an edge, a bending portion extended from the edge, a fold-back portion connected to the bending portion, and a nut with a screw hole riveted on the fold-back portion. The fold-back portion is folded back toward the base plate.

Another embodiment of the invention provides the metal display casing, which includes a base plate having an edge, a bending portion extended from the edge, a fold-back portion connected to the bending portion, and a screw hole formed on the fold-back portion. The fold-back portion is folded back toward the base plate. The screw hole includes a punch wall and plural internal threads formed on the punch wall. The thickness of the punch wall is larger than a thickness of the base plate.

Another embodiment of the invention provides a display, which includes a metal display casing, a display panel, a frame, and a screw. The metal display casing includes a base plate having an edge, a bending portion extended from the edge, a fold-back portion connected to the bending portion, and a nut with a screw hole riveted on the fold-back portion. The fold-back portion is folded back toward the base plate. The display panel is fixed on the frame, and the frame is screwed on the metal display casing.

Another embodiment of the invention provides the display, which includes a metal display casing, a display panel, a frame, and a screw. The metal display casing includes a base plate having an edge, a bending portion extended from the edge, a fold-back portion connected to the bending portion, and a screw hole formed on the fold-back portion. The fold-back portion is folded back toward the base plate. The screw hole includes a punch wall and plural internal threads formed on the punch wall. The thickness of the punch wall is larger than a thickness of the base plate. The display panel is fixed on the frame, and the frame is screwed on the metal display casing.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of a first embodiment of the metal display casing of the invention;

FIG. 2 is a cross-sectional diagram of the first embodiment of the metal display casing of the invention;

FIG. 3 is a schematic diagram of a display utilized in the first embodiment of the metal display casing of the invention;

FIG. 4 is a schematic diagram of a second embodiment of the metal display casing of the invention;

FIG. 5 is a cross-sectional diagram of the second embodiment of the metal display casing of the invention; and

FIG. 6 is a schematic diagram of a display utilized in the second embodiment of the metal display casing of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

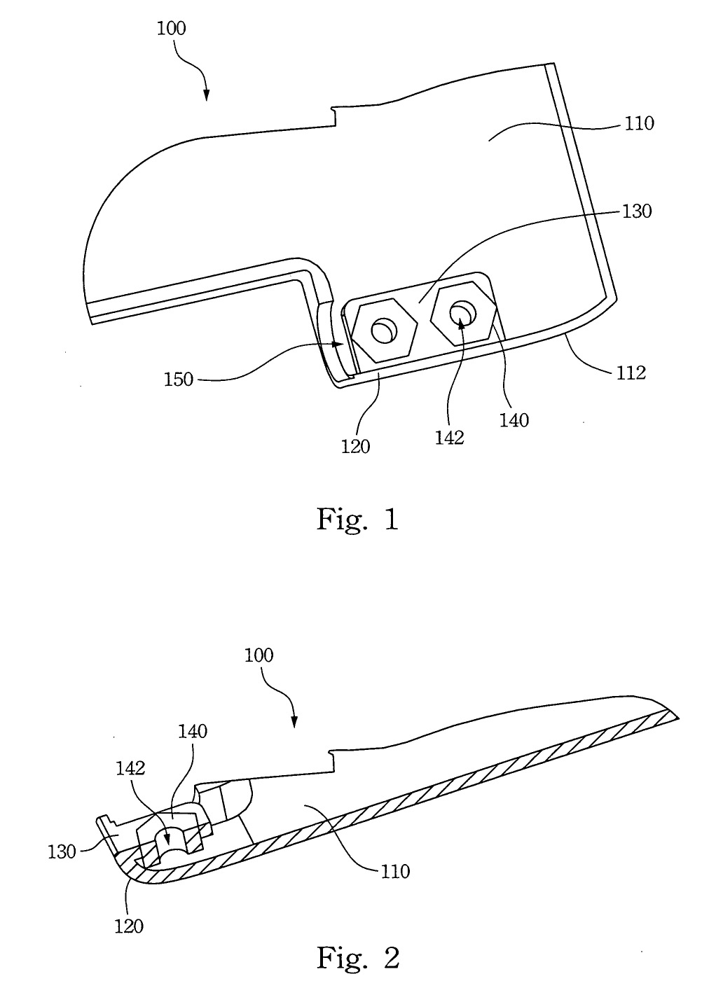

Refer to FIG. 1. FIG. 1 illustrates a schematic diagram of a first embodiment of the metal display casing of the invention. The metal display casing 100 includes a base plate 110, a bending portion 120 extended from an edge 112 of the base plate 110, a fold-back portion 130 connected to the bending portion 120, and a nut 140 riveted on the fold-back portion 130. The fold-back portion 130 is folded back toward the base plate 110. The base plate 110, the bending portion 120, and the fold-back portion 130 are formed as a U-shaped structure.

The metal display casing 100 is made by punching a metal board, and then the predetermined areas of the metal board are bent to form the bending portion 120 and the fold-back portion 130. The base plate 110, the bending portion 120, and the fold-back portion 130 are integrally formed by the metal board. The material of the metal display casing 100 can be aluminum.

The nut 140 is riveted on the fold-back portion 130. The nut 140 has a screw hole 142. The fold-back portion 130 with the screw hole 142 can be regarded as a connecting structure, thus other components can be screwed on the fold-back portion 130 of the metal display casing 100. The metal display casing 100 includes a hinge opening 150. The bending portion 120 and the fold-back portion 130 are disposed next to the hinge opening 150.

Refer to FIG. 2. FIG. 2 illustrates a cross-sectional diagram of the first embodiment of the metal display casing of the invention. The base plate 110, the bending portion 120, and the fold-back portion 130 of the metal display casing 100 are formed as the U-shaped structure. The fold-back portion 130 is approximately parallel to the base plate 110. The nut 140 is a countersunk head nut in this embodiment, thus the surface of the fold-back portion 130 can be as flat as possible. The nut 140 has the screw hole 142, and the fold-back portion 130 with the screw hole 142 can be regarded as the connecting structure of the metal display casing 100.

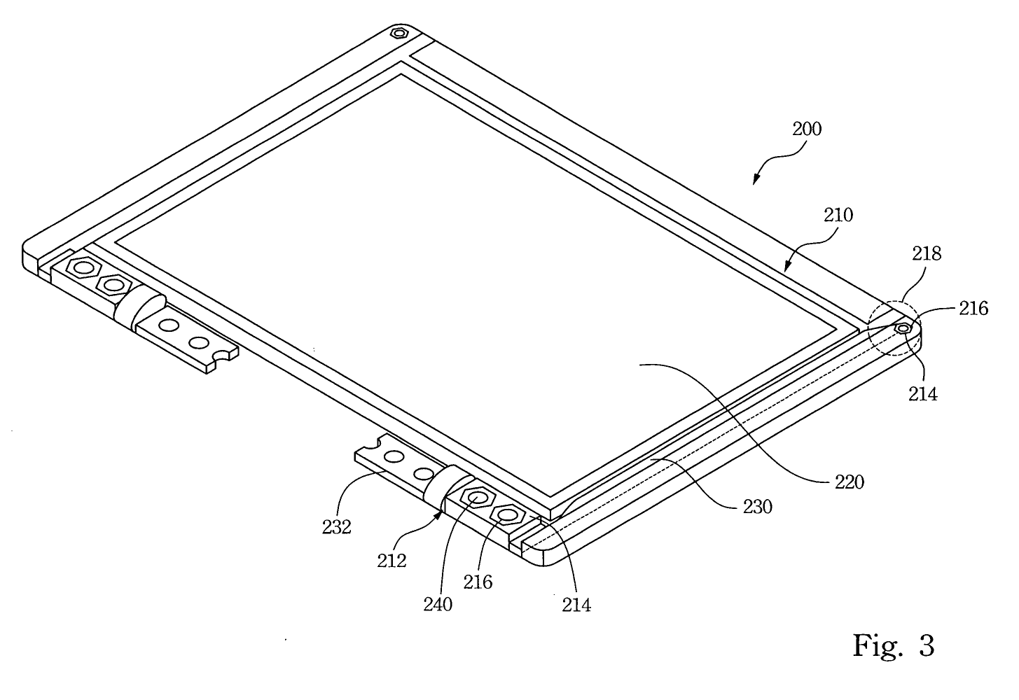

Refer to FIG. 3. FIG. 3 illustrates a schematic diagram of a display utilized in the first embodiment of the metal display casing of the invention. The display 200 includes the metal casing 210, the display panel 220, and a frame 230. The display panel 220 is fixed on the frame 230, and then the frame 230 is further screwed on the metal display casing 210. The frame 230 has a hinge 232. The metal display casing 210 has the hinge opening 212, plural fold-back portions 214, and nuts 216. One of the fold-back portions 214 is disposed next to the hinge opening 212. The nuts 216 are riveted on the fold-back portions 214 respectively. The hinge 232 of the frame 230 passes through the hinge opening 212 of the metal display casing 210. The display 200 has a screw 240 to screw the hinge 232 of the frame 230 on the fold-back portion 214.

The metal display casing 210 includes plural corners 218. In this embodiment, some of the fold-back portions 214 are disposed at the corners 218, and the nuts 216 are riveted on the fold-back portions 214. The frame 230 can be screwed on the fold-back portions 214 by the nuts 216.

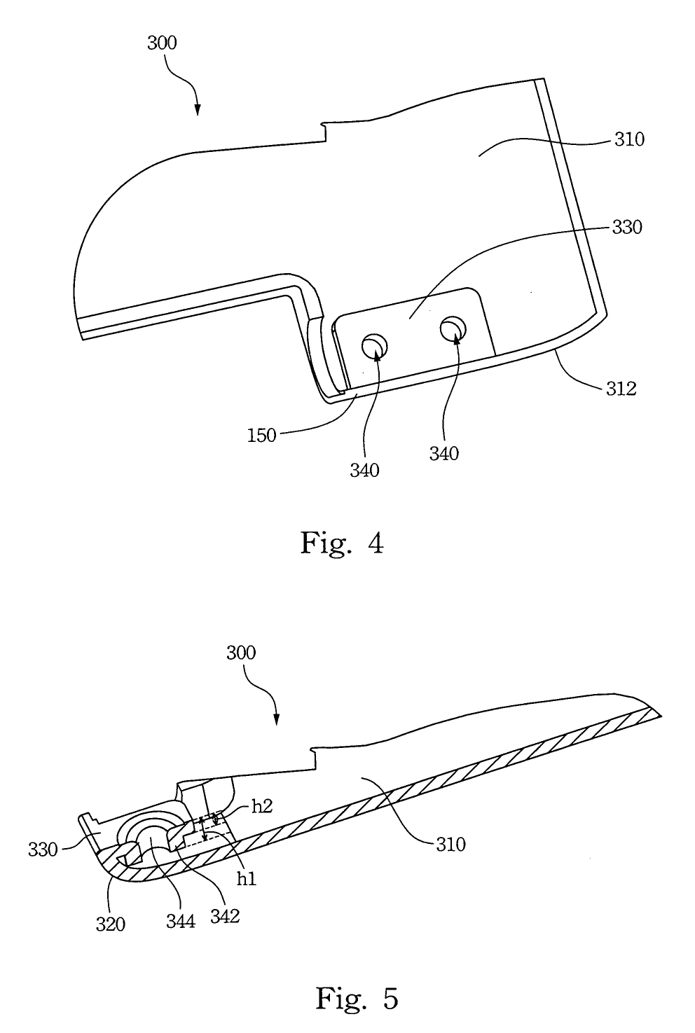

Refer to FIG. 4. FIG. 4 illustrates a schematic diagram of a second embodiment of the metal display casing of the invention. The metal display casing 300 includes the base plate 310, the bending portion 320 extended from the edge 312 of the base plate 310, the fold-back portion 330 connected to the bending portion 320, and a screw hole 340 formed on the fold-back portion directly. The fold-back portion 330 is folded back toward the base plate 310. The base plate 310, the bending portion 320, and the fold-back portion 330 are formed as the U-shaped structure.

As the embodiment disclosed previously, the metal display casing 300 is made by punching a metal board, and then the predetermined areas of the metal board are bent to form the bending portion 320 and the fold-back portion 330. The base plate 310, the bending portion 320, and the fold-back portion 330 are integrally formed by the metal board. The material of the metal display casing 300 can be aluminum. The screw hole 340 is formed by drilling the metal board by a burring punch.

Refer to FIG. 5. FIG. 5 illustrates a cross-sectional diagram of the second embodiment of the metal display casing of the invention. The base plate 310, the bending portion 320, and the fold-back portion 330 are formed as the U-shaped structure. The fold-back portion 330 is approximately parallel to the base plate 310. The number of the threads formed on the fold-back potion 330 by tapping the fold-back portion 330 directly would be limited by the thickness of the fold-back portion 330, which is the same as the metal board. The lesser the number of threads formed on the fold-back portion 330 would reduce the screw strength of the fold-back portion 330. Thus the present embodiment provides additional steps to increase the number of the threads formed on the fold-back portion 330.

The fold-back portion 330 in the present embodiment is punched by a burring punch to form a punch wall 342 thereon, and then tapping the punch wall 342 to form plural internal threads 344 on the punch wall 342. The punch wall 342 is formed on the fold-back potion 330 by punching the burring punch, thus the thickness h1 of the punch wall 342 is larger than the thickness h2 of the fold-back portion 330, and the number of the internal threads 344 formed on the punch wall 342 can be increased. The punching and tapping process can be practiced before the metal board is punched. The punching and tapping process can be practice after forming the bending portion 320 and the fold-back portion 330. The punch wall 342 is extruded toward the base plate 310. The opening punched by the burring punch of the punch wall 342 is curved.

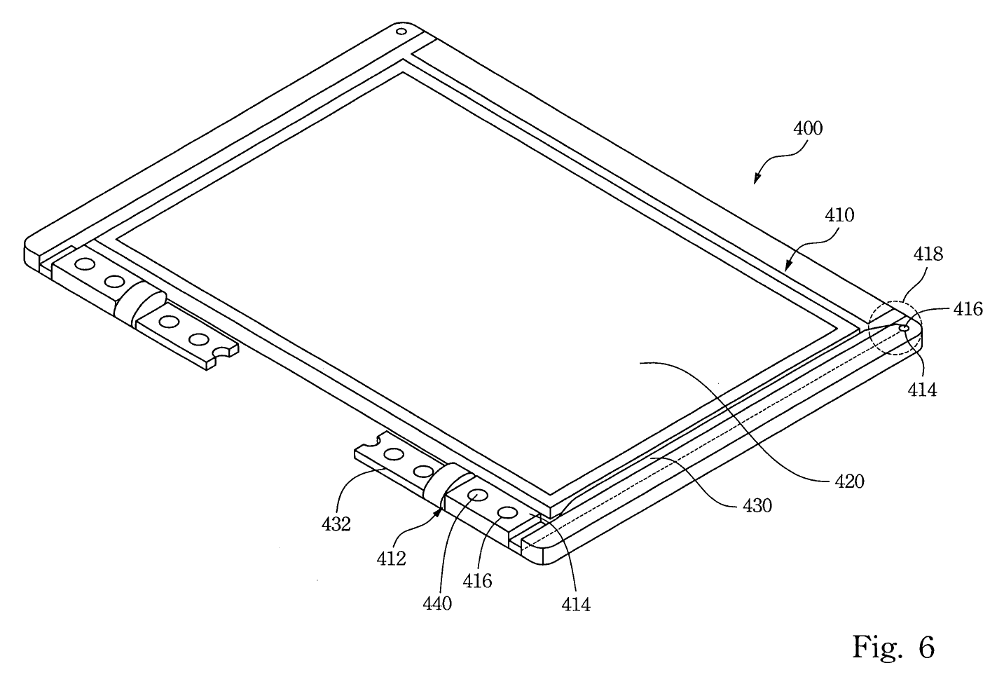

Refer to FIG. 6. FIG. 6 illustrates a schematic diagram of a display utilized in the second embodiment of the metal display casing of the invention. The display 400 includes the metal display casing 410, the display panel 420, and the frame 430. The display panel 420 is fixed on the frame 430, and then the frame 430 is screwed on the metal display casing 410. The frame 430 has the hinge 432. The metal display casing 410 has the hinge opening 412 and plural fold-back portions 414 with the screw holes 416. One of the fold-back portions 414 is disposed next to the hinge opening 412. The hinge 432 of the frame 430 passes through the hinge opening 412 of the metal display casing 410. The display 400 has the screw 440 to screw the hinge 432 of the frame 430 on the fold-back portion 414 with the screw hole 416.

The metal display casing 410 includes plural corners 418. In this embodiment, some of the fold-back portions 414 are disposed at the corners 418. The frame 430 can be further screwed on the fold-back portions 414 with the screw hole 416 to enhance the screw strength.

The fold-back portion can be formed by bending the metal board. The screw hole is formed on the fold-back portion by riveting the nut on the fold-back portion or the punching and tapping process. The fold-back portion with the screw hole can be regarded as the connecting structure, so that the frame can be screwed on the metal display casing without an additional plastic connecting structure.

Although the present invention has been described in considerable detail with reference to certain preferred embodiments thereof, other embodiments are possible. Therefore, the spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A metal display casing comprising:
a base plate comprising an edge;
a bending portion extended from the edge;
a fold-back portion connected to the bending portion, wherein the fold-back portion is folded back toward the base plate; and
a nut comprising a screw hole and riveted on the fold-back portion.

2. The metal display casing of claim 1, wherein the fold-back portion is approximately parallel to the base plate.

3. The metal display casing of claim 1, wherein a material of the metal display casing comprises aluminum.

4. The metal display casing of claim 1, wherein the nut is a countersunk head nut.

5. The metal display casing of claim 1, further comprising a hinge opening, wherein the bending portion and the fold-back portion are disposed next to the hinge opening.

6. A metal display casing comprising:
a base plate comprising an edge;
a bending portion extended from the edge;
a fold-back portion connected to the bending portion, wherein the fold-back portion is folded back toward the base plate; and
a screw hole formed on the fold-back portion, the screw hole comprising:
a punch wall, wherein a thickness of the punch wall is larger than a thickness of the base plate; and
a plurality of internal threads formed on the punch wall.

7. The metal display casing of claim 6, wherein the fold-back portion is approximately parallel to the base plate.

8. The metal display casing of claim 6, wherein a material of the metal display casing comprises aluminum.

9. The metal display casing of claim 6, further comprising a hinge opening, wherein the bending portion and the fold-back portion are disposed next to the hinge opening.

10. A display comprising:
a metal display casing comprising:
a base plate comprising an edge;
a bending portion extended from the edge;
a fold-back portion connected to the bending portion, wherein the fold-back portion is folded back toward the base plate; and
a nut comprising a screw hole and riveted on the fold-back portion;
a frame;
a display panel fixed on the frame; and
a screw to screw the frame on the fold-back portion of the metal display casing.

11. The display of claim 10, wherein the fold-back portion is approximately parallel to the base plate.

12. The display of claim 10, wherein the nut is a countersunk head nut.

13. The display of claim 10, wherein the metal display casing further comprises a hinge opening, wherein the bending portion and the fold-back portion are disposed next to the hinge opening.

14. The display of claim 13, wherein the frame comprises a hinge, and the hinge passes through the hinge opening and is screwed on the fold-back portion by the screw.

15. The display of claim 10, wherein the metal display casing comprises a corner, and the fold-back portion is disposed at the corner.

16. A display comprising:
a metal display casing comprising:
a base plate comprising an edge;
a bending portion extended from the edge;
a fold-back portion connected to the bending portion, wherein the fold-back portion is folded back toward the base plate; and
a screw hole formed on the fold-back portion, wherein the screw hole comprises a punch wall and a plurality of internal threads formed on the punch wall, wherein a thickness of the punch wall is larger than a thickness of the base plate;
a frame;
a display panel fixed on the frame; and
a screw to screw the frame on the fold-back portion of the metal display casing.

17. The display of claim 16 wherein the fold-back portion is approximately parallel to the base plate.

18. The display of claim 16 wherein the metal display casing further comprises a hinge opening, wherein the bending portion and the fold-back portion are disposed next to the hinge opening.

19. The display of claim 18 wherein the frame comprises a hinge, and the hinge passes through the hinge opening and is screwed on the fold-back portion by the screw.

20. The display of claim 16, wherein the metal display casing comprises a corner, and the fold-back portion is disposed at the corner.
